(19) United States
(12) Patent Application Publication
(10) Pub. No.: US 2025/0377971 A1
(43) Pub. Date: Dec. 11, 2025

(54) CIRCUITS, SYSTEMS AND/OR PROCESSES FOR INSTRUCTION SEQUENCE TEST ERROR TRACKING

(71) Applicant: Arm Limited, Cambridge (GB)

(72) Inventors: Karthikeyan Shanmugam, Bangalore (IN); Uma Renuka Subramanyam Pitchuka, Bangalore (IN); Nitin Gupta, Bangalore (IN)

(21) Appl. No.: 18/736,147

(22) Filed: Jun. 6, 2024

(51) Int. Cl. G06F 11/263

(52) U.S. Cl. CPC G06F 11/08; G06F 11/263

(57) ABSTRACT

The present disclosure relates generally to integrated circuits and relates more particularly to circuits, systems, and/or processes for instruction sequence test error tracking.

### BACKGROUND

### Field:

The present disclosure relates generally to integrated circuits and relates more particularly to circuits, systems, and/or processes for instruction sequence test error tracking.

### Information:

Integrated circuit devices, such as processors, for example, may be found in a wide range of electronic device types. Computing devices, for example, may include integrated circuit devices, such as processors, to process signals and/or states representative of diverse content types for a variety of purposes. Over time, various techniques and technologies have evolved in an effort to test integrated circuits, such as processors, for example, to verify design and/or implementation. In some circumstances, processors, for example, may be tested via random instruction sequence (RIS) tools and/or techniques whereby a sequence of executable instructions may be executed and results compared with expected results, for example. However, challenges remain in creating testing tools and/or techniques that capture a satisfactory percentage of errors and/or that provide satisfactory coverage of the various circuits, functionalities, etc., of the device under test, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram illustrating example processing circuitry, in accordance with an embodiment;

FIG. 2 is a diagram depicting an example random instruction sequence (RIS) testing operation, in accordance with an embodiment;

FIG. 3 is a diagram depicting an example comparison of RIS testing runs, in accordance with an embodiment;

FIG. 4 is a schematic block diagram depicting an example circuit for iteratively calculating hash values based at least in part on test stream data, in accordance with an embodiment;

FIG. 5 is a flow diagram depicting an example algorithm for iteratively calculating hash values based at least in part on test stream data, in accordance with an embodiment;

FIG. 6 is a diagram depicting an example instruction sequence test operation, in accordance with an embodiment; and

FIG. 7 is a schematic block diagram illustrating an example apparatus including a processing element and data caches, in accordance with an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned, integrated circuit devices, such as processors, for example, may be found in a wide range of electronic device types. Computing devices, for example, may include integrated circuit devices, such as processors, to process signals and/or states representative of diverse content types for a variety of purposes. Over time, various techniques and technologies have evolved in an effort to test processors to verify design and/or implementation. In some circumstances, processors may be tested via random instruction sequence (RIS) tools and/or techniques whereby a sequence of executable instructions may be executed and results compared with expected results, for example. However, challenges remain in creating testing tools and/or techniques that capture a satisfactory percentage of errors and/or that provide satisfactory coverage of the various circuits, functionalities, etc., of the device under test, for example. Non-limiting example embodiments described herein may be directed to addressing these challenges.

For example, in embodiments, an apparatus may include execution circuitry to execute a current set of instructions of an instruction sequence test operation, wherein the execution circuitry stores results of the current set of instructions in one or more first data registers. The apparatus may also include hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation, for example.

In implementations, the current set of instructions may comprise one or more instructions and/or the previous set of instructions may comprise one or more instructions that immediately precede the current set of instructions. Also, in implementations, the current set of instructions may comprise a single instruction and/or the previous set of instructions comprise a single instruction to immediately precede the current set of instructions. In implementations, an apparatus may further comprise a hash value register to store the calculated hash value for the current set of instructions.

In implementations, a hash value for the current set of instructions may comprise a cyclic redundancy check value, and/or a hash value for the previous set of instructions may also comprises a cyclic redundancy check value, for example. In implementations, hash value calculation circuitry may comprise circuitry to calculate a cyclic redundancy check value for a current set of instructions based at least in part on one or more data elements obtained from one or more specified data registers, including at least one or more first data registers, and further based at least in part on a cyclic redundancy check value for the previous set of instructions.

In implementations, an apparatus may further comprise selection circuitry to indicate to the hash value calculation circuitry one or more specified data registers. In implementations, the selection circuitry may comprise a selection register to store one or more data elements indicative of the one or more specified data registers.

In implementations, an apparatus may further comprise a control circuit to enable, halt, and/or pause calculation of hash values by the hash value calculation circuitry responsive at least in part to a first specified value written to a control register. Also, in implementations, the control circuit may reset the hash value register responsive at least in part to a second specified value written to the control register.

In implementations, an apparatus may further comprise a selection register to store one or more data elements indicative of the one or more specified data registers, a control register to store one or more data elements to indicate to a control circuit to enable, halt, reset, and/or pause calculation of hash values; and a hash value register to store the calculated hash value for the current set of instructions, wherein the selection register, the control register, and/or the hash value register are accessible via execution of one or more instructions. In implementations, the execution circuitry and the hash value calculation circuitry are located in a first processor core. Further, in implementations, the one or more data elements obtained from the one or more specified data registers may comprise the previously-calculated hash value.

In implementations, an apparatus may further comprise circuitry to, responsive to a calculation of the hash value for the current set of instructions, write the hash value for the current set of instructions from the hash value register to at least one of the one or more specified data registers for use in a subsequent set of instructions to be executed by the execution circuitry as part of the instruction sequence test operation.

In implementations, an apparatus may further comprise circuitry to, responsive to a calculation of the hash value for the current set of instruction wherein execution of the current set of instructions is to have cleared at least one of the one or more specified data registers, write the hash value for the current set of instructions from the hash value register to the at least one of the one or more specified data registers.

Embodiments may include a process, including executing, by execution circuitry of a first processor core, a current set of instructions of an instruction sequence test operation, including storing results of the current set of instructions in one or more first data registers, calculating, via hash value calculation circuitry of the first processor core, a hash value for the current set of instructions based, at least in part, on one or more data elements obtained from one or more specified data registers, including at least the one or more first data registers, and further based at least in part on a previously-calculated hash value for a previous set of instructions of the instruction sequence test operation, and storing the calculated hash value for the current iteration in a hash value register.

In implementations, an example process may also comprise writing one or more data elements indicative of the one or more specified data registers in a selection register, writing one or more data elements to a control register to indicate to a control circuit to enable, halt, reset, and/or pause calculation of hash values, and writing the hash value for the current set of instructions to a memory in accordance with one or more additional instructions decoded by an instruction decode unit, wherein the selection register, the control register, and/or the hash value register are accessible via execution of one or more instructions. In implementations, an example process may further comprise, responsive to the calculation of the hash value for the current set of instructions, writing the calculated hash value for the current set of instructions from the hash value register to at least one of the one or more specified data registers for use in a subsequent set of instructions to be executed by the execution circuitry as part of the instruction sequence test operation.

In implementations, an example process may further comprise writing the hash value for the current set of instructions from the hash value register to at least one of the one or more specified data registers responsive to the calculating the hash value for the current set of instructions wherein executing the current set of instructions results in clearing the at least one of the one or more specified data registers.

Embodiments may also include a non-transitory computer-readable medium to store computer-readable code for fabrication of an apparatus comprising execution circuitry to execute a current set of instructions of an instruction sequence test operation, wherein the execution circuitry is to store results of the current set of instructions in one or more first data registers, and also comprising hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation.

Aspects related to example embodiments and/or implementations mentioned above may be described in greater detail below. Of course, subject matter is not limited in scope to examples described herein.

As mentioned, integrated circuits capable of executing instructions, such as processors, may be tested via random instruction sequence (RIS) tools and/or techniques, for example, whereby a sequence of executable instructions may be executed and results compared with expected results, for example. Embodiments may be directed to capturing a satisfactory percentage of errors and/or to providing satisfactory coverage of various circuits, functionalities, etc., of devices under test, for example.

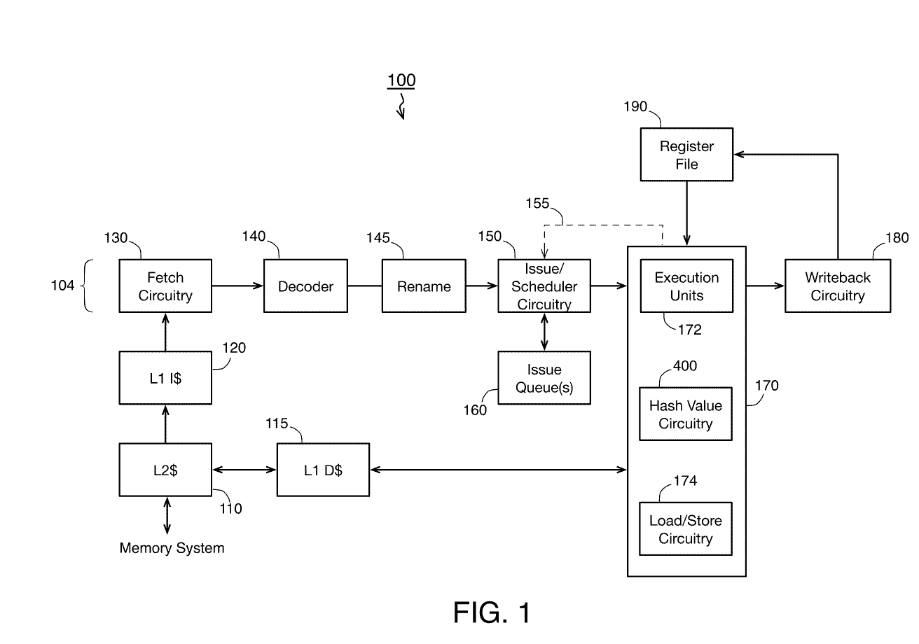

FIG. 1 is a schematic block diagram illustrating an embodiment of example processing circuitry 100 that may, for example, be subjected to testing (e.g., RIS). In implementations, processing circuitry, such as processing circuitry 100, may comprise a processing pipeline, such as processing pipeline 104, that may include a number of pipeline stages. In implementations, processing pipeline 104 may include fetch circuitry, such as fetch circuitry 130, for fetching program instructions from an instruction cache. For example, processing circuitry may include a first level instruction cache (L1I$), such as L1I$ 120, that may provide a more localized cache of instructions to be provided to fetch circuitry 130. Processing pipeline 104 may also include a decoding stage, such as decoder 140, for decoding fetched program instructions to generate decoded instructions, such as micro-operations, to be processed by remaining stages of processing pipeline 104. Processing pipeline 104 may additionally comprise a rename stage 145 to maintain a speculative mapping between a set of architecturally defined registers and a plurality of physical registers in register file 190, for example.

In implementations, processing pipeline 104 may comprise an issue stage, such as issue/scheduler circuitry 150, for checking whether operands required for decoded micro-operations are ready in register file 190 (e.g., operands have been generated via execution of earlier-issued instructions) and/or for issuing instructions for execution once the required operands for a given instruction are ready. One or more issue queues 160 may hold instructions awaiting issuance to an execute stage 170, for example. Execute stage 170 may include one or more execution units 172 for executing data processing operations corresponding to the instructions at least in part by processing operands read from the register file 190 to generate result values. A writeback stage, such as writeback circuitry 180, may also write the result values back to register file 190. In implementations, availability of results for use as source operands may be communicated by execute stage 170 to issue/scheduler circuitry 150, as indicated in FIG. 1 by a schematic data path 155. Implementations discussed herein may include any of a number of techniques, processes, etc. for communicating availability of operands to issue/scheduler circuitry, such as issue/scheduler circuitry 150.

In implementations, executions unit(s) 172 may include any of a number of processing units for executing different classes or categories of micro-operations. For example, execution units 172 may include one or more of an arithmetic/logic unit (ALU) for performing arithmetic or logical operations, a floating-point unit for performing operations on floating-point values, and/or a branch unit for evaluating outcomes of branch operations. In implementations, execution units 172 may comprise multiple types of execution units so that micro-operations of different categories may be executed in parallel and/or may comprise multiple instances of a particular type of execution unit so that multiple micro-operations of a particular type may be executed in parallel.

In implementations, execution stage 170 may comprise a load/store unit, such as load/store circuitry 174, for performing load/store operations to access data in one or more caches, memories, etc. Processing circuitry 100, for example, may include a first level data cache (L1D$), such as L1D$ 115, a second level cache (L2$), such as L2$ 110, and a main system memory (not shown). Also, as mentioned, L1I$ 120 may provide instructions to fetch circuitry 130, for example.

In implementations, execution stage 170 may include one or more circuits 400 for calculating hash values based at least in part on test stream data, as discussed more fully below.

It may be appreciated that processing circuitry 100 is merely an example, and subject matter is not limited in scope in these respects. It may be further appreciated that FIG. 1 is merely a simplified representation of some components of a possible processor pipeline architecture, and processing circuitry 100, for example, may include other elements not illustrated for conciseness.

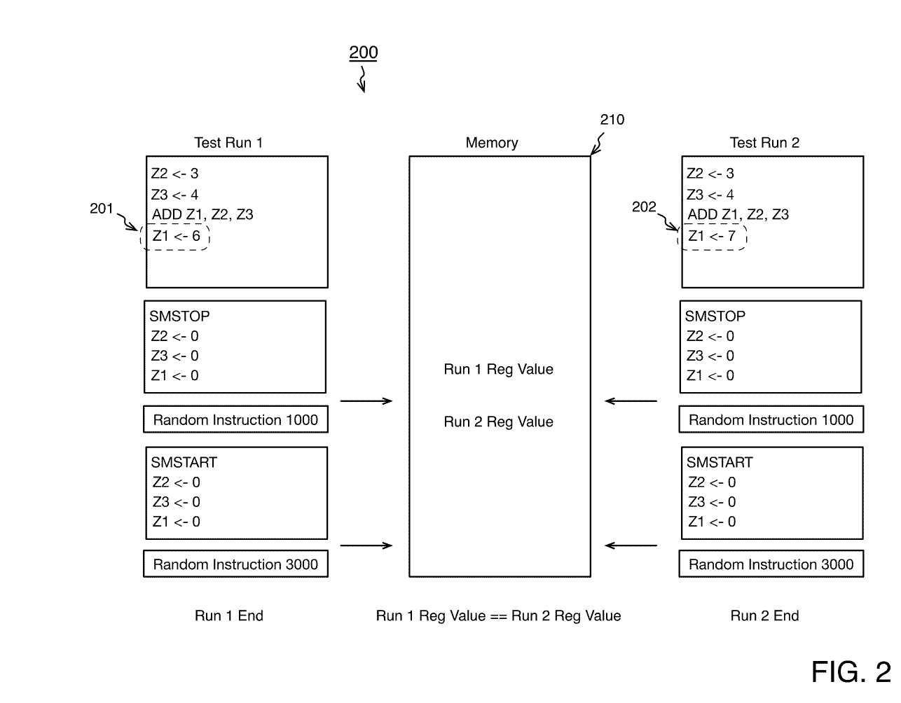

FIG. 2 is a diagram depicting an example random instruction sequence (RIS) testing operation 200. As mentioned, RIS generators may be effective tools for functional verification of processors, for example. In implementations, tests generated via RIS tools may contain hundreds of instructions. To simplify explanation, example test operation 200 is depicted in FIG. 2 as including merely a few instructions. Of course, other implementations may include a greater number of instructions.

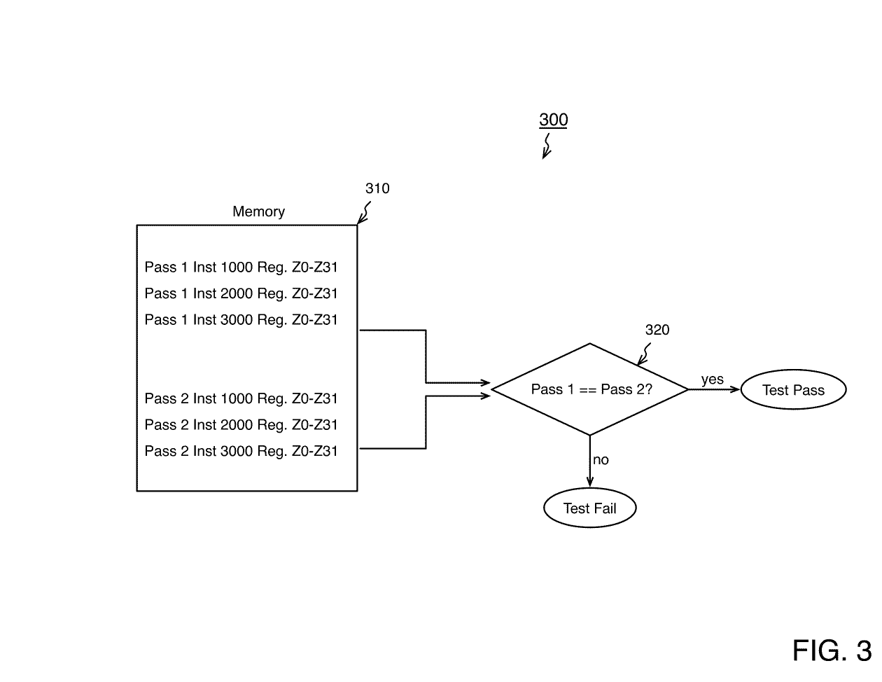

In FIG. 2, two runs of an example test (Test Run 1 and Test Run 2) are depicted. FIG. 2 and FIG. 3 together show one example of processor verification that may be referred to as consistency checking. During each test run, generated instructions (e.g., randomly generated instructions) may be executed by a processor undergoing verification testing. For example testing operation 200, two runs of identical instructions may be executed. During execution of each test run, register contents may be written to a memory, such as memory 210. In some implementations, register contents may be written to memory at the end of each test run. In other implementations, register contents may be written to memory at specified intervals during the test runs. As indicated in FIG. 2, register contents for test run 1 may be compared with register contents for test run 2. If the comparison matches, the two test runs may be assumed to be identical in execution and testing operation 200 may be deemed successful. A mismatch of register values for the two test runs may indicate that an error occurred somewhere during one of the test runs.

FIG. 3 is a diagram depicting an example process 300 for comparing register values resulting from instruction sequence testing runs (e.g., pass 1 and pass 2). As indicated, following execution of specified instructions, such as Instruction 1000, 2000, and 3000, for example, register values may be written to a memory, as shown at block 310 of FIG. 3. Separate values may be stored for pass 1 and pass 2, as also indicated. Further, as depicted at block 320, if register values from pass 1 match corresponding register values from pass 2, the verification test passes. If non-matching register values are detected, the verification test fails. However, as shown in FIG. 2 and as discussed below, it is possible for errors to be missed even in circumstances wherein the register values for pass 1 and pass 2 of an instruction sequence match.

For example, returning to FIG. 2, each test run for example testing operation 200 may include an ADD instruction wherein values from registers Z2 and Z3 are added and a result is stored in register Z1. Following the ADD instruction, an SMSTOP (streaming mode stop) instruction may be executed wherein values of “0” are written to registers Z1, Z2, and Z3. In implementations, register values for test run 1 and test run 2 may be written to a memory, such as memory 210, following the SMSTOP instruction.

Further, for example testing operation 200, each test run may additionally include a Random Instruction 1000 followed by an SMSTART (streaming mode start) operation. As with the SMSTOP instruction, SMSTART may include writing values of “0” to registers Z1, Z2, and Z3. Also, test runs 1 and 2 may also include a Random Instruction 3000. In implementations, register values for test run 1 and test run 2 may again be written to memory 210 following execution of Random Instruction 3000. As mentioned, a comparison of register values from both test runs should show a match. Non-matching values may indicate that an error has occurred.

However, as may be seen in the ADD instruction from test run 1, values of “3” from register Z2 and “4” from register Z3 are added and a resulting value of “6” is stored to register Z1. Clearly, an error has occurred. For example, the corresponding ADD instruction from test run 2 shows a result of “7,” which is correct. However, because the subsequent SMSTOP and/or SMSTART instructions write values of “0” to registers Z1, Z2, and Z3, the erroneous results of the ADD instruction from test run 1 are demolished. Because the erroneous value does not persist, the comparison of register values for test run 1 and test run 2 will show a match even though an error occurred during test run 1.

Although example test operation 200 merely shows a few instructions for each test run, it may be seen that memory locations and/or data registers may be continuously modified due to instruction execution during test runs. If results of one instruction are demolished via execution of a subsequent instruction, it is possible for errors to be missed, even if the run 1 register values (Run 1 Reg Value) matches the run 2 register values (Run 2 Reg Value). Further, although particular example instructions (e.g., SMSTOP, SMSTART) are shown in FIG. 2, subject matter is not limited in scope in these respects.

To address the issues described above, a data flow hash register may be implemented, for example. Generally, a hash value may be regularly (e.g., continuously, periodically, etc.) calculated based at least in part on current values from various data registers, processor state registers, etc., and further based at least in part on a previous hash value. In this manner, an error occurring during a test run will be carried through to the end of the test run rather than potentially being decimated by a subsequent instruction.

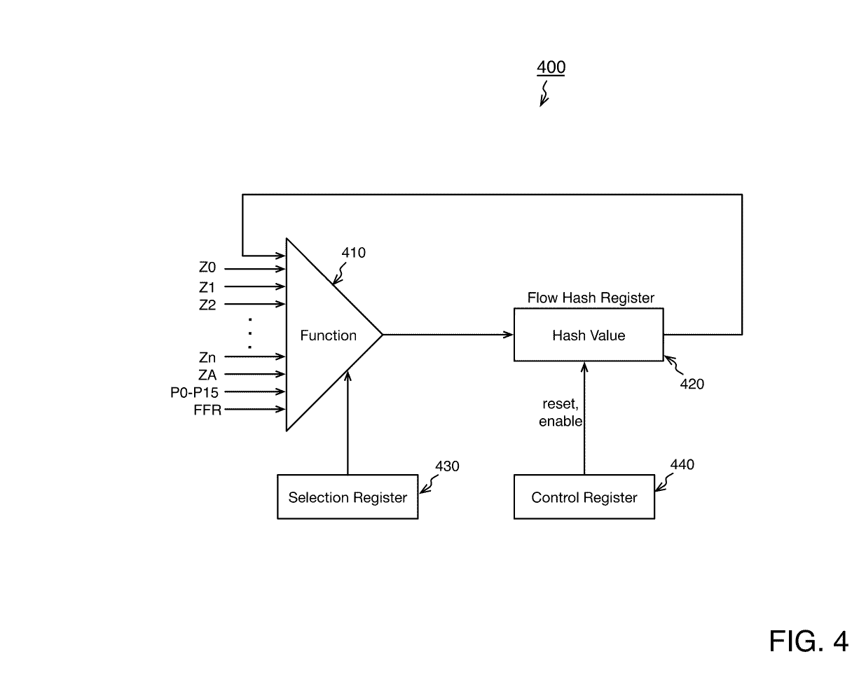

For example, embodiments may include execution circuitry to execute, a current set of instructions of an instruction sequence test operation, wherein the execution circuitry is to store results of the current set of instructions in one or more first data registers. Embodiments may also include hash value calculation circuitry to calculate a hash value for the current set of instructions based at least in part on one or more data elements obtained from one or more specified data registers, including at least the one or more first data registers, for example, and further based at least in part on a previously-calculated hash value for a previous set of instructions of the instruction sequence test operation. In implementations, a set of instructions may comprise a single instruction or may include more than one instruction. Also, hash values may be calculated after every instruction in some implementations. However, in other implementations, hash values may be calculated after each set of instructions (e.g., after every few instructions). In implementations, the frequency at which to calculate hash values may depend, at least in part, on a specified performance parameter for the instruction test sequence and/or on available computing resources, for example. FIGS. 4-6, described below, provide additional detail for example implementations. Of course, subject matter is not limited in scope to the particular examples discussed herein.

FIG. 4 is a schematic block diagram depicting an embodiment 400 of an example circuit for periodically and/or iteratively calculating hash values based at least in part on test stream data. For example, as mentioned, hash values may be calculated responsive to execution of individual instructions of an instruction set sequence or may be calculated responsive to execution of individual sets of instructions (e.g., one or more instructions). In an implementation, hash value calculation circuit 410 may calculate a hash value based at least in part on data values from one or more registers and further based at least in part on a previously-calculated hash value for one or more previous instructions.

For example, for a current set of instructions (e.g., one or more instructions) of an instruction sequence test operation, hash calculation circuit 400 may calculate a hash value based on one or more of data registers Z0-Zn and ZA, processor state registers P0-P15, and/or first fault register FFR and also based on a hash value for a previous set of instructions (e.g., one or more previously executed instructions) obtained from hash value register 420. A feedback loop may be noted between hash value register 420 and hash value calculation circuit 410 (e.g., whereby hash values may be iteratively calculated).

In implementations, a goal may be to have any errors that occur during a test run flow through the test run until a value showing the error can be saved. Rather than incur the overhead of saving a checksum following each instruction, for example, hash values may be stored, wherein the hash values may store a current state of a processor (e.g., compressed state) and that also may reflect any error that may have occurred during execution of a current set of instructions (e.g., one or more current instructions) and/or during execution of a previous set of instructions (e.g., one or more previous instructions).

In implementations, hash values from hash value register 420 may be stored to a memory at specified intervals, for example. In implementations, hash value register 420 may be accessed via a control register, such as control register 440. For example, control register 440 may be accessed to cause a reset of hash register 420, to enable calculation and/or storage of hash values, to stop and/or pause testing operations, etc. For example, an exception (e.g., interrupt) may move execution of instructions via execution unit(s) 172 away from an instruction test sequence. In such a circumstance, calculation of hash values may be paused until the instruction test sequence resumes, for example. For example, resumption of hash value calculation may be affected via control register 440, in implementations.

In implementations, hash value register 420 may match the bit width of one or more of data registers Z0-Zn, although subject matter is not limited in scope in this respect. Also, for example, hash value calculation circuit 410 may calculate cyclic redundancy check (CRC) values. That is, for example, hash values may comprise CRC values in implementations. Again, subject matter is not limited in scope in this respect.

FIG. 4 also depicts a selection register 430, for example. In implementations, selection register 430 may specify which registers and/or values that are to be included in hash value calculations. As mentioned, for the current non-limiting example implementation, hash value calculation circuit 410 may calculate a hash value for a current set of instructions of an instruction sequence test based at least in part on values from one or more data registers Z0-Zn and/or ZA, processor state registers P0-P15, and/or first fault register FFR. Any or all of these registers may be selected for inclusion in hash value calculation via selection register 430, in implementations.

In implementations, hash value calculation circuit 410 and/or hash value register 420 may be implemented within a pipeline stage, such as execution unit(s) 172, of a processor core, such as processing pipeline 104, for example.

In implementations, a mechanism may be provided so that read hash value register 420 may be accessible via software, for example. Also, for example, control register 440 may be reset via software so that the lifetime of the hash value may be controlled, in implementations. In implementations, hash value register 420 may be reset via control register 440 at the beginning of an instruction sequence test, for example. Of course, subject matter is not limited in scope in these respects.

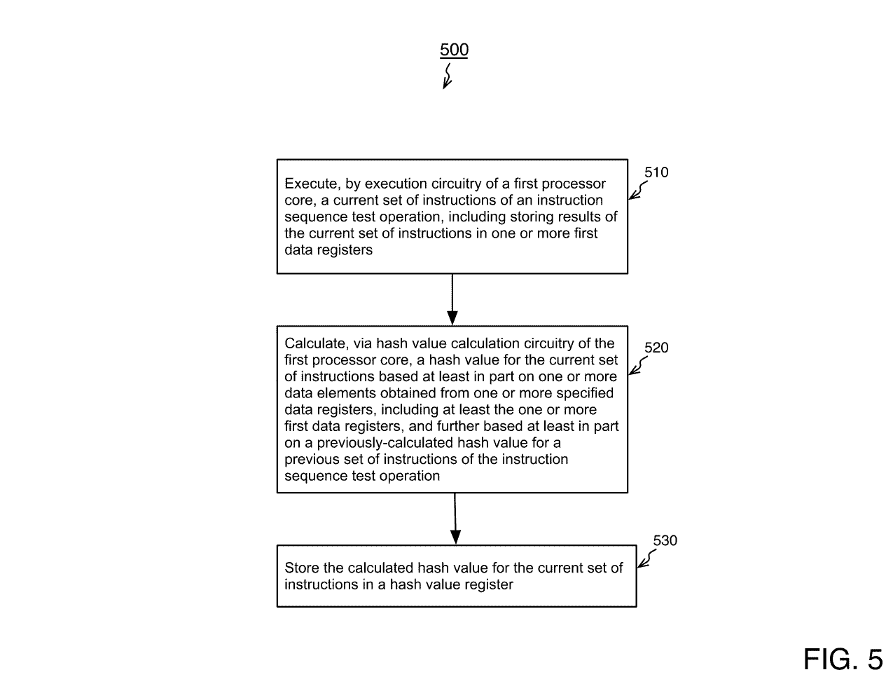

FIG. 5 is a flow diagram depicting an embodiment 500 of an example process for calculating hash values based at least in part on test stream data. Embodiments may include all of the operations described, fewer than the operations described, and/or more than the operations described for example process 500. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations, processes, techniques, approaches, etc. are illustrated or described concurrently or with respect to a certain sequence, other sequences or concurrent operations may be employed. In addition, although the description below references particular aspects and/or features illustrated in certain other figures, one or more operations, processes, techniques, approaches, etc. may be performed with other aspects and/or features.

In implementations, example process 500 may include an operation to execute, by execution circuitry (e.g., execution unit(s) 172) of a first processor core (e.g., processor pipeline 104) a current set of instructions of an instruction sequence test operation, including storing results of the current set of instructions in one or more first data registers, as indicated at block 510. Also, in implementations, process 500 may also include an operation to calculate, via hash value calculation circuitry (e.g., hash value calculation circuit 410) of the first processor core (e.g., processor pipeline 104), a hash value for the current set of instructions, based at least in part, on one or more data elements obtained from one or more specified data registers (e.g., data registers Z0-Z15, ZA), including at least the one or more first data registers, and further based at least in part on a previously-calculated hash value for a previous set of instructions of the instruction sequence test operation, as indicated at block 520, for example. Further, as indicated at block 520, the calculated hash value for the current set of instructions of the instruction sequence test operation may be stored in a hash value register, such as hash value register 420, for example.

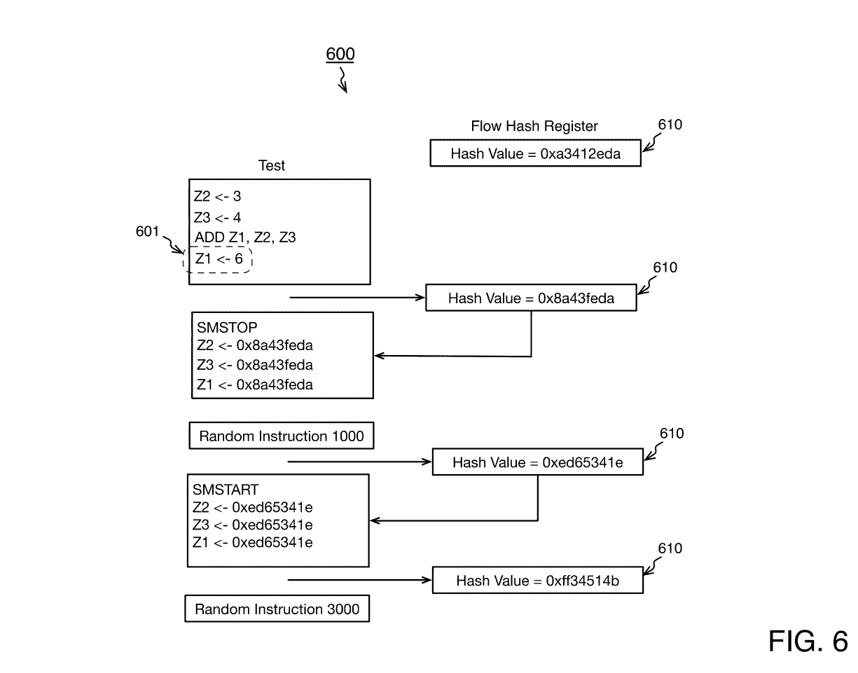

FIG. 6 is a diagram depicting an embodiment 600 of an example instruction sequence test operation. As depicted in FIG. 6, some implementations may include writing calculated hash values to specified registers to ensure that errors will persist throughout a test run so that the errors may be detected. That is, for example, calculated hash values may be utilized to initialize registers to preserve continuity of test data values.

For example, the test sequence of FIG. 6 shares some similarity to test runs 1 and 2 of FIG. 2. For example, test sequence 600 may include an erroneous result of an ADD instruction. See result 601, for example. In implementations, a hash value may be calculated following the ADD instruction and may be stored in a hash value register 610. Further, for example, for the SMSTOP instruction, registers Z1, Z2, and Z3 may be initialized with a previously-calculated hash value (e.g., hash value = 0x8a43feda). Random instruction 1000 may be executed, and a hash value may be calculated. The hash value may again be stored to hash value register 610, and the hash value may further be utilized to initialize registers Z1, Z2, and Z3 for instruction SMSTART, for example. Following the SMSTART instruction, a hash value may again be calculated and stored to hash value register 610. In this manner, any error that may occur during the test run may be propagated via the hash values.

By calculating hash values based on data elements from specified data registers and further based on previously-calculated hash values, and/or by recalculating and storing hash values at specified intervals, a greater number of errors may be detected while reducing overhead and while improving processor test coverage. Further, because hash calculation does not require software mechanisms to store and/or restore register values, for example, there may be less dilution of an instruction sequence test operation, for example.

In implementations, hash values stored in a hash value register, such as hash value register 420, may be written out to a memory through MRS (program status register to general purpose register) and/or MSR (general purpose register to program status register) instructions, for example. In implementations, a target register, such as hash value register 420, may be accessed by providing a specified encoding to MRS instructions to read out a hash value, for example. Further, in implementations, selection register 430 and/or control register 440 may be accessed in a similar manner.

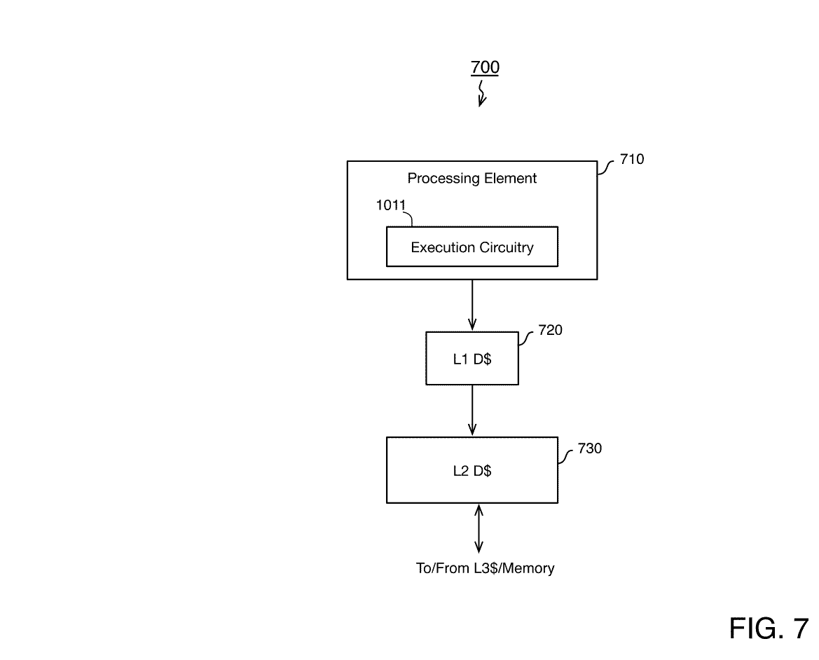

FIG. 7 illustrates an example of an apparatus 700 comprising a processing element 710 (e.g. a CPU or GPU) comprising execution circuitry 711 for executing processing operations in response to decoded program instructions. Processing element 710 may have access to a first-level data cache (L1D$) 720 and a second level data cache (L2D$) 730, which may comprise part of a cache hierarchy including multiple caches for caching data from memory that is accessible by processing element 710 in response to load/store operations executed by the execution circuitry 711, for example. Example embodiments and/or implementations of processing circuitry and/or execution circuitry are described herein in connection with FIGS. 1-6, for example.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII, for example. The one or more netlists or other computer-readable representation of integrated circuit components may be generated by applying one or more logic synthesis processes to an RTL representation to generate definitions for use in fabrication of an apparatus embodying embodiments, such as those described herein, for example. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly, for example.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying embodiments, such as those described herein, for example. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept, for example.

Embodiments may also be described, at least in part, by the following numbered clauses: Clause 1. An apparatus, comprising: execution circuitry to execute a current set of instructions of an instruction sequence test operation, wherein the execution circuitry is to store results of the current set of instructions in one or more first data registers; and hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation.

Clause 2. The apparatus of clause 1, wherein the current set of instructions comprises one or more instructions and wherein the previous set of instructions comprises one or more instructions to immediately precede the current set of instructions.

Clause 3. The apparatus of any of the aforementioned clauses, wherein the current set of instructions comprises a single instruction and wherein the previous set of instructions comprises a single instruction to immediately precede the current set of instructions.

Clause 4. The apparatus of any of the aforementioned clauses, further including a hash value register to store the calculated hash value for the current set of instructions.

Clause 5. The apparatus of any of the aforementioned clauses, wherein the hash value for the current set of instructions comprises a cyclic redundancy check value for the current set of instructions, and wherein the hash value for the previous set of instructions comprises a cyclic redundancy check value for the previous set of instructions.

Clause 6. The apparatus of any of the aforementioned clauses, wherein the hash value calculation circuitry comprises circuitry to calculate the cyclic redundancy check value for the current set of instructions based at least in part on the one or more data elements obtained from the one or more specified data registers, including at least the one or more first data registers, and further based at least in part on the cyclic redundancy check value for the previous set of instructions.

Clause 7. The apparatus of any of the aforementioned clauses, further comprising selection circuitry to indicate to the hash value calculation circuitry the one or more specified data registers.

Clause 8. The apparatus of any of the aforementioned clauses, wherein the selection circuitry comprises a selection register to store one or more data elements indicative of the one or more specified data registers.

Clause 9. The apparatus of any of the aforementioned clauses, further comprising a control circuit to enable, halt, and/or pause calculation of hash values by the hash value calculation circuitry responsive at least in part to a first specified value written to a control register.

Clause 10. The apparatus of any of the aforementioned clauses, wherein the control circuit is to reset the hash value register responsive at least in part to a second specified value written to the control register.

Clause 11. The apparatus of any of the aforementioned clauses, further comprising: a selection register to store one or more data elements indicative of the one or more specified data registers; a control register to store one or more data elements to indicate to a control circuit to enable, halt, reset, and/or pause calculation of hash values; and a hash value register to store the calculated hash value for the current set of instructions; wherein the selection register, the control register, and/or the hash value register are accessible via execution of one or more instructions.

Clause 12. The apparatus of any of the aforementioned clauses, wherein the execution circuitry and the hash value calculation circuitry are located in a first processor core.

Clause 13. The apparatus of any of the aforementioned clauses, wherein the one or more data elements obtained from the one or more specified data registers comprise the previously-calculated hash value.

Clause 14. The apparatus of any of the aforementioned clauses, further comprising circuitry to, responsive to a calculation of the hash value for the current set of instructions, write the hash value for the current iteration from the hash value register to at least one of the one or more specified data registers for use in a subsequent set of instructions to be executed by the execution circuitry as part of the instruction sequence test operation.

Clause 15. The apparatus of any of the aforementioned claims, further comprising circuitry to, responsive to a calculation of the hash value for the current set of instructions wherein execution of the current set of instructions is to have cleared at least one of the one or more specified data registers, write the hash value for the current set of instructions from the hash value register to the at least one of the one or more specified data registers.

Clause 16. A method, comprising: executing, by execution circuitry of a first processor core, a current set of instructions of an instruction sequence test operation, including storing results of the current set of instructions in one or more first data registers; calculating, via hash value calculation circuitry of the first processor core, a hash value for the current set of instructions based, at least in part, on one or more data elements obtained from one or more specified data registers, including at least the one or more first data registers, and further based at least in part on a previously-calculated hash value for a previous set of instructions of the instruction sequence test operation; and storing the calculated hash value for the current iteration in a hash value register.

Clause 17. The method of any clause 16, further comprising: writing one or more data elements indicative of the one or more specified data registers in a selection register; writing one or more data elements to a control register to indicate to a control circuit to enable, halt, reset, and/or pause calculation of hash values; and writing the hash value for the current set of instructions to a memory in accordance with one or more additional instructions decoded by an instruction decode unit; wherein the selection register, the control register, and/or the hash value register are accessible via execution of one or more instructions.

Clause 18. The method of any of clauses 16-17, further comprising, responsive to the calculation of the hash value for the current set of instructions, writing the calculated hash value for the current set of instructions from the hash value register to at least one of the one or more specified data registers for use in a subsequent set of instructions to be executed by the execution circuitry as part of the instruction sequence test operation.

Clause 19. The method of any of clauses 16-18, further comprising writing the hash value for the current set of instructions from the hash value register to at least one of the one or more specified data registers responsive to the calculating the hash value for the current set of instructions wherein executing the current set of instructions results in clearing the at least one of the one or more specified data registers.

Clause 20. A non-transitory computer-readable medium to store computer-readable code for fabrication of an apparatus comprising: execution circuitry to execute a current set of instructions of an instruction sequence test operation, wherein the execution circuitry is to store results of the current set of instructions in one or more first data registers; and hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation.

It will be clear to one skilled in the art that many improvements and modifications can be made to the foregoing exemplary embodiments without departing from the scope of the present techniques.

What is claimed is:

1. An apparatus, comprising:
execution circuitry to execute a current set of instructions of an instruction sequence test operation, wherein the execution circuitry is to store results of the current set of instructions in one or more first data registers; and
hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation.

2. The apparatus of claim 1, wherein the current set of instructions comprises one or more instructions and wherein the previous set of instructions comprises one or more instructions to immediately precede the current set of instructions.

3. The apparatus of claim 1, wherein the current set of instructions comprises a single instruction and wherein the previous set of instructions comprises a single instruction to immediately precede the current set of instructions.

4. The apparatus of claim 1, further including a hash value register to store the calculated hash value for the current set of instructions.

5. The apparatus of claim 1, wherein the hash value for the current set of instructions comprises a cyclic redundancy check value for the current set of instructions, and wherein the hash value for the previous set of instructions comprises a cyclic redundancy check value for the previous set of instructions.

6. The apparatus of claim 5, wherein the hash value calculation circuitry comprises circuitry to calculate the cyclic redundancy check value for the current set of instructions based at least in part on the one or more data elements obtained from the one or more specified data registers, including at least the one or more first data registers, and further based at least in part on the cyclic redundancy check value for the previous set of instructions.

7. The apparatus of claim 1, further comprising selection circuitry to indicate to the hash value calculation circuitry the one or more specified data registers.

8. The apparatus of claim 7, wherein the selection circuitry comprises a selection register to store one or more data elements indicative of the one or more specified data registers.

9. The apparatus of claim 1, further comprising a control circuit to enable, halt, and/or pause calculation of hash values by the hash value calculation circuitry responsive at least in part to a first specified value written to a control register.

10. The apparatus of claim 9, wherein the control circuit is to reset the hash value register responsive at least in part to a second specified value written to the control register.

11. The apparatus of claim 1, further comprising:
a selection register to store one or more data elements indicative of the one or more specified data registers;
a control register to store one or more data elements to indicate to a control circuit to enable, halt, reset, and/or pause calculation of hash values; and
a hash value register to store the calculated hash value for the current set of instructions;
wherein the selection register, the control register, and/or the hash value register are accessible via execution of one or more instructions.

12. The apparatus of claim 1, wherein the execution circuitry and the hash value calculation circuitry are located in a first processor core.

13. The apparatus of claim 1, wherein the one or more data elements obtained from the one or more specified data registers comprise the previously-calculated hash value.

14. The apparatus of claim 1, further comprising circuitry to, responsive to a calculation of the hash value for the current set of instructions, write the hash value for the current set of instructions from the hash value register to at least one of the one or more specified data registers for use in a subsequent set of instructions to be executed by the execution circuitry as part of the instruction sequence test operation.

15. The apparatus of claim 1, further comprising circuitry to, responsive to a calculation of the hash value for the current set of instructions wherein execution of the current set of instructions is to have cleared at least one of the one or more specified data registers, write the hash value for the current set of instructions from the hash value register to the at least one of the one or more specified data registers.

16. A method, comprising:
executing, by execution circuitry of a first processor core, a current set of instructions of an instruction sequence test operation, including storing results of the current set of instructions in one or more first data registers;
calculating, via hash value calculation circuitry of the first processor core, a hash value for the current set of instructions based, at least in part, on one or more data elements obtained from one or more specified data registers, including at least the one or more first data registers, and further based at least in part on a previously-calculated hash value for a previous set of instructions of the instruction sequence test operation; and
storing the calculated hash value for the current iteration in a hash value register.

17. The method of claim 16, further comprising:
writing one or more data elements indicative of the one or more specified data registers in a selection register;
writing one or more data elements to a control register to indicate to a control circuit to enable, halt, reset, and/or pause calculation of hash values; and
writing the hash value for the current set of instructions to a memory in accordance with one or more additional instructions decoded by an instruction decode unit;
wherein the selection register, the control register, and/or the hash value register are accessible via execution of one or more instructions.

18. The method of claim 16, further comprising, responsive to the calculation of the hash value for the current set of instructions, writing the calculated hash value for the current set of instructions from the hash value register to at least one of the one or more specified data registers for use in a subsequent set of instructions to be executed by the execution circuitry as part of the instruction sequence test operation.

19. The method of claim 16, further comprising writing the hash value for the current set of instructions from the hash value register to at least one of the one or more specified data registers responsive to the calculating the hash value for the current set of instructions wherein executing the current set of instructions results in clearing the at least one of the one or more specified data registers.

20. A non-transitory computer-readable medium to store computer-readable code for fabrication of an apparatus comprising:
execution circuitry to execute a current set of instructions of an instruction sequence test operation, wherein the execution circuitry is to store results of the current set of instructions in one or more first data registers; and
hash value calculation circuitry to calculate a hash value for the current set of instructions based at least in part on one or more data elements obtained from one or more specified data registers, including at least the one or more first data registers, and further based at least in part on a previously-calculated hash value for a previous set of instructions of the instruction sequence test operation.
